(19) United States
(12) Patent Application Publication
(10) Pub. No.: US 2018/0074492 A1
(43) Pub. Date: Mar. 15, 2018

(54) VEHICLE CONTROL DEVICE

(71) Applicant: HONDA MOTOR CO., LTD, Tokyo (JP)

(72) Inventors: Yusuke Yamamoto, Wako-shi (JP); Takemi Tsukada, Wako-shi (JP); Nobuharu Nagaoka, Wako-shi (JP)

(21) Appl. No.: 15/696,429

(22) Filed: Sep. 6, 2017

(30) Foreign Application Priority Data
Sep. 12, 2016 (JP) 2016-177375

(51) Int. Cl. G05D 1/00; G05D 1/02; B60W 40/08; B60W 40/06; B60W 50/14

(52) U.S. Cl. CPC G05D 1/0061; G05D 1/0212; B60W 40/08; B60W 40/06; B60W 50/14; G06K 9/00798; B60W 2550/10; B60W 2550/22; B60W 2550/30; B60W 2510/202; B60W 2040/0809

(57) ABSTRACT

An automatic driving control unit initiates automatic driving under a condition in which, after a manual driving recognition unit has recognized execution of manual driving, and a right/left turn recognition unit has recognized completion of a right or left turn of the vehicle, a state of being capable of generating a target travel trajectory by a trajectory generating unit is brought about, and in addition, the manual driving recognition unit no longer recognizes execution of manual driving.

### CROSS-REFERENCE TO RELATED APPLICATION

This application is based upon and claims the benefit of priority from Japanese Patent Application No. 2016-177375 filed on Sep. 12, 2016, the contents of which are incorporated herein by reference.

### BACKGROUND OF THE INVENTION

### Field of the Invention

The present invention relates to a vehicle control device that temporarily stops automatic driving when a vehicle turns to the left or right, and initiates (resumes) automatic driving after having turned to the right or left by way of manual driving.

### Description of the Related Art

An automatically driven vehicle travels autonomously on a travel route which is set, by automatically controlling a driving force device, a steering device, and a braking device on the basis of information from the outside world. In certain automatically driven vehicles, when making a turn to the right or left at an intersection or the like during automatic driving, automatic driving is temporarily stopped and switched to manual driving.

In Japanese Laid-Open Patent Publication No. 2016-050901, a system is disclosed for initiating (resuming) automatic driving after having switched from automatic driving to manual driving. In this system, a branch point (an intersection or the like) in a planned travel route is traversed by way of manual driving by the driver. In addition, after having passed through the branch point, automatic driving is initiated (resumed) on the condition that the vehicle is parallel to the lane markings, or an automatic driving start button is operated, or an operative device such as the accelerator pedal is not operated within a fixed time.

### SUMMARY OF THE INVENTION

In certain cases, the driver may wish to resume automatic driving quickly after having made a right or left turn by way of manual driving at an intersection or the like. However, if the fact that the vehicle is parallel to the lane markings is taken as the condition for resumption of automatic driving as disclosed in Japanese Laid-Open Patent Publication No. 2016-050901, then automatic driving is not restarted during the period that the vehicle is not parallel to the lane markings. Further, if operation of an automatic driving start button is taken as the condition for resumption of automatic driving, then it becomes necessary to undertake a complex operation such as operating the button. Further, if not having operated an operative device such as the accelerator pedal for a fixed time period is taken as the condition for resumption of automatic driving, then a comparatively long time is required until automatic driving is resumed. In this manner, the conditions for resumption of automatic driving as disclosed in Japanese Laid-Open Patent Publication No. 2016-050901 are incapable of sufficiently satisfying the driver's desire to rapidly resume automatic driving. Therefore, it cannot necessarily be said that the system disclosed in Japanese Laid-Open Patent Publication No. 2016-050901 enables automatic driving to be initiated appropriately in all cases.

The present invention has been devised taking into consideration the aforementioned problems, and an object of the present invention is to provide a vehicle control device which is capable of rapidly resuming automatic driving without the need for complicated operations by the driver.

The present invention is characterized by a vehicle control device disposed in a vehicle that is capable of traveling by automatic driving, including a right/left turn recognition unit configured to recognize a right or left turn of the vehicle, a trajectory generating unit configured to generate a target travel trajectory for the vehicle, a manual driving recognition unit configured to recognize that manual driving is being executed, and an automatic driving control unit configured to initiate automatic driving under a condition in which, after the manual driving recognition unit has recognized execution of manual driving, and the right/left turn recognition unit has recognized the completion of a right or left turn of the vehicle, a state of being capable of generating the target travel trajectory by the trajectory generating unit is brought about, and in addition, the manual driving recognition unit no longer recognizes execution of manual driving. According to the present invention, since automatic driving is resumed unless the driver is engaged in manual driving at a point in time when the target travel trajectory is capable of being generated, and after having made a right or left turn by way of manual driving, it is possible for automatic driving to be resumed rapidly without requiring the driver to perform a complicated operation such as operating a button.

The trajectory generating unit may generate the target travel trajectory along a travel route following a road. According to the present invention, when automatic driving is taking place following a road for which a destination point is not set, the driver performs only right or left turning at intersections by way of manual driving, and thereafter, automatic driving can be continued.

The vehicle control device may further include an own vehicle position recognition unit configured to recognize a current position of the vehicle, and a vehicle operation recognition unit configured to recognize an operation of the vehicle, wherein, regardless of the condition, if the own vehicle position recognition unit recognizes that the current position is within a lane, and the vehicle operation recognition unit recognizes that an amount of change per unit time of the vehicle in a vehicle widthwise direction is greater than or equal to a predetermined amount, then the automatic driving control unit need not initiate automatic driving. According to the present invention, automatic driving is not resumed when an amount of change (amount of motion) per unit time of the vehicle in the vehicle widthwise direction is large. More specifically, since there are no significant steering operations being performed immediately after switching from manual driving to automatic driving, the riding comfort of the vehicle can be favorably maintained.

The vehicle control device may further include a vehicle operation recognition unit configured to recognize an operation of the vehicle, wherein, regardless of the condition, if the vehicle operation recognition unit recognizes that a velocity of the vehicle is greater than or equal to a predetermined velocity, or the vehicle operation recognition unit recognizes that an acceleration or deceleration of the vehicle is greater than or equal to a predetermined acceleration or deceleration, then the automatic driving control unit need not initiate automatic driving. According to the present invention, automatic driving is not resumed when the velocity of the vehicle is greater than or equal to a predetermined velocity, or when the acceleration or deceleration is greater than or equal to a predetermined acceleration or deceleration. More specifically, since there are no significant acceleration or deceleration operations being performed immediately after switching from manual driving to automatic driving, the riding comfort of the vehicle can be favorably maintained.

The vehicle control device may further include an obstacle recognition unit configured to recognize an obstacle in front of the vehicle, wherein, regardless of the condition, if the obstacle is recognized by the obstacle recognition unit, then the automatic driving control unit need not initiate automatic driving. In the event that an obstacle is present in front of the vehicle after having made a right or left turn, it is more efficient for manual driving to be continued as is, and to carry out a contact avoidance action, rather than carrying out such a contact avoidance action by way of automatic driving after having switched from manual driving to automatic driving. According to the present invention, if an obstacle is present in front of the vehicle, automatic driving is not initiated, and therefore, it is possible to efficiently perform the contact avoidance action with respect to the obstacle.

The vehicle control device may further include a road shape recognition unit configured to recognize a curvature of a travel path, wherein, regardless of the condition, if the road shape recognition unit recognizes that the curvature is greater than or equal to a predetermined curvature, then the automatic driving control unit need not initiate automatic driving. During automatic driving, when the curvature of the travel path in front of the vehicle is large, in certain cases, driving of the vehicle should be entrusted to the driver. According to the present invention, automatic driving is not initiated in the case that the curvature of the travel path in front of the vehicle is large. More specifically, since there is no need for such a series of operations that switching is made from manual driving to automatic driving immediately after having made a right or left turn, and immediately thereafter, switching is made again from automatic driving to manual driving due to the curvature of the travel path being large, the processing burden at the time of switching the driving mode is eliminated. Further, since automatic driving is not stopped again immediately after having been initiated, it is possible to prevent the driver from being confused.

The vehicle control device may further include a road shape recognition unit configured to recognize a width of the travel path, wherein, regardless of the condition, if the road shape recognition unit recognizes that the width is less than or equal to a predetermined width, then the automatic driving control unit need not initiate automatic driving. During automatic driving, when the width of the travel path in front of the vehicle is small, in certain cases, driving of the vehicle should be entrusted to the driver. According to the present invention, automatic driving is not initiated in the case that the width of the travel path in front of the vehicle is small. More specifically, since there is no need for such a series of operations that switching is made from manual driving to automatic driving immediately after having made a right or left turn, and immediately thereafter, switching is made again from automatic driving to manual driving due to the width of the travel path being small, the processing burden at the time of switching the driving mode is eliminated. Further, since automatic driving is not stopped again immediately after having been initiated, it is possible to prevent the driver from being confused.

The vehicle control device may further include a traffic signal recognition unit configured to recognize the presence or absence of a traffic signal installed in front of the vehicle, and a signal shown by the traffic signal, wherein, regardless of the condition, if the traffic signal recognition unit recognizes that the traffic signal is present, but does not recognize the signal shown by the traffic signal, then the automatic driving control unit need not initiate automatic driving. If it is recognized that there is a traffic signal in front of the vehicle after having made a right or left turn, and the signal shown by the traffic signal cannot be recognized, it is more efficient to continue manual driving as is, and to entrust the determination of operations to the driver. According to the present invention, in the case it is recognized that there is a traffic signal in front of the vehicle, yet the signal shown by the traffic signal cannot be recognized, automatic driving is not initiated, and therefore, the vehicle can be driven efficiently.

The vehicle control device may further include a driver recognition unit configured to recognize a driver, wherein, regardless of the condition, if the driver recognition unit recognizes that the driver is not in a state suitable for manual driving, then the automatic driving control unit need not initiate automatic driving. In general, in a vehicle that is in the process of being driven automatically, in preparation for a sudden request to change from automatic driving to manual driving, it is preferable for the driver to be in a state suitable for performing manual driving, for example, in a state of sitting or visually confirming the front of the vehicle. For this reason, a condition suitable for manual driving may be set as a requirement for automatic driving. According to the present invention, automatic driving is not initiated in the case of a state that is unsuitable for manual driving, or in other words, since automatic driving is only initiated in a state suitable for manual driving, it is possible to satisfy the requirement for automatic driving.

The vehicle control device may further include a preceding vehicle recognition unit configured to recognize a preceding vehicle traveling in front of the vehicle, wherein, if the preceding vehicle is recognized by the preceding vehicle recognition unit, then the automatic driving control unit may determine the start of automatic driving on the basis of the preceding vehicle. According to the present invention, in the case that a preceding vehicle can be recognized, it is possible to perform automatic driving in following relation to the preceding vehicle.

If a rate of change of an inter-vehicle distance as recognized by the preceding vehicle recognition unit is less than a rate of change threshold value, then the automatic driving control unit need not initiate automatic driving.

The vehicle control device may further include a lane marking recognition unit configured to recognize a lane marking of a lane in which the vehicle is traveling, wherein, if the preceding vehicle is not recognized by the preceding vehicle recognition unit, then the automatic driving control unit may determine the start of automatic driving on the basis of the lane marking recognized by the lane marking recognition unit. According to the present invention, even if a preceding vehicle cannot be recognized, in the event that lane markings can be recognized, the vehicle can be made to travel along the lane markings.

The lane marking recognition unit may recognize an angle between a longitudinal direction of the vehicle and a direction in which the lane marking extends, and if the angle recognized by the lane marking recognition unit is greater than or equal to an angle threshold value, then the automatic driving control unit need not initiate automatic driving.

The manual driving recognition unit may recognize a steering torque input by a steering wheel, and when a steering turning-back operation is performed, the automatic driving control unit may delay a time of starting automatic driving in the case that a steering torque in the turning-back direction is recognized by the manual driving recognition unit, and may hasten a time of starting automatic driving in the case that the steering torque in the turning-back direction is not recognized by the manual driving recognition unit. When a steering turning-back operation is performed, in the case that a steering torque in the turning-back direction is generated, such a turning-back operation is performed by the driver. In other words, the driver positively carries out manual driving. On the other hand, when a steering turning-back operation is performed, in the case that a steering torque in the turning-back direction is not generated, such a turning-back operation is performed by a self-aligning torque. In other words, the driver leaves the responsibility for driving to the vehicle. According to the present invention, when the driver leaves the responsibility for driving to the vehicle, it is possible to rapidly initiate automatic driving.

The vehicle control device may further include a notification control unit configured to instruct a notification device concerning a procedure for initiating automatic driving, in the case that manual driving is recognized by the manual driving recognition unit even if an elapsed time from having recognized the completion of a right or left turn of the vehicle by the right/left turn recognition unit is greater than or equal to a predetermined time. According to the present invention, it is possible to remind or cause the driver to realize that automatic driving can be initiated.

According to the present invention, it is possible to rapidly resume automatic driving without the need for the driver to perform a complicated operation such as operating a button.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a block diagram showing a vehicle in which a vehicle control device according to an embodiment of the present invention is installed;

FIG. 2 is a functional block diagram of the vehicle control device;

FIG. 3 is a flowchart of a process for initiating (resuming) automatic driving;

FIG. 4 is a flowchart of the process for initiating (resuming) automatic driving; and

FIG. 5 is a flowchart of the process for initiating (resuming) automatic driving.

### DESCRIPTION OF THE PREFERRED EMBODIMENTS

A preferred embodiment of a vehicle control device according to the present invention will be presented and described in detail below with reference to the accompanying drawings.

### 1. Configuration of Automatically Driven Vehicle 10

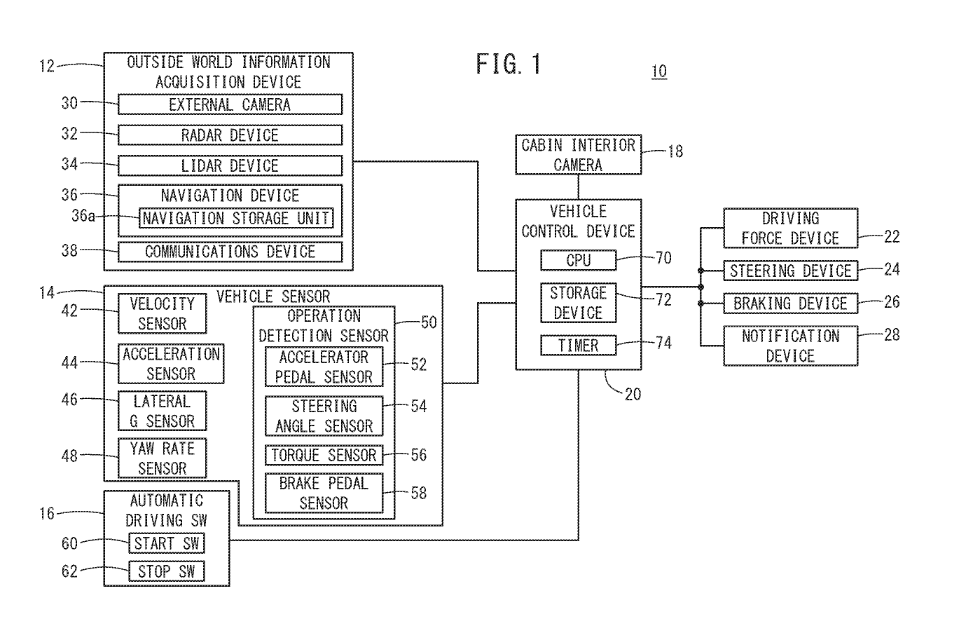

As shown in FIG. 1, a vehicle control device 20 according to the present embodiment is provided in an automatically driven vehicle 10 (hereinafter also referred to as a “vehicle 10”). The vehicle 10 includes an outside world information acquisition device 12, vehicle sensors 14, an automatic driving switch 16 (hereinafter also referred to as an “automatic driving SW 16”), a cabin interior camera 18, a vehicle control device 20, a driving force device 22, a steering device 24, a braking device 26, and a notification device 28.

The outside world information acquisition device 12 includes a plurality of external cameras 30, a plurality of radar devices 32, a plurality of LIDAR devices 34, a navigation device 36, and a communications device 38. The external cameras 30 capture images of the surrounding vicinity of the vehicle 10, and acquire image information. The radar devices 32 irradiate electromagnetic waves around the periphery of the vehicle 10, and detect reflected waves with respect to the irradiated electromagnetic waves. The LIDAR devices 34 irradiate laser light around the periphery of the vehicle 10, and detect scattered light with respect to the irradiated laser light. It is also possible to use a fusion sensor that fuses the image information acquired by the external cameras 30 and the detected information acquired by the radar devices 32.

The navigation device 36 includes a navigation storage unit 36a in which map information is stored. The map information includes, for example, shape information of roads, lane node information, position information of intersections, information concerning the presence or absence of traffic signals, position information of stop lines, and the like. The navigation device 36 measures the current position (travel position) of the vehicle 10 using detected information from a satellite positioning device and the vehicle sensors 14, etc., and generates a travel route from such a position to a destination point designated by the user. The navigation device 36 includes, as a user interface thereof, operation switches (including a touch panel), a display, and a speaker. The navigation device 36 displays the generated travel route, and guides the vehicle along the travel route by voice.

The communications device 38 enables communications with other communications devices, which are provided in a roadside device, other vehicles, a server, or the like. The communications device 38 transmits and receives information in relation to traffic signals, etc., information in relation to other vehicles, probe information, and updated map information, and the like.

The vehicle sensors 14 include a plurality of sensors for detecting various behaviors of the vehicle. For example, among the vehicle sensors 14, there are included a velocity sensor 42 that detects the velocity (vehicle velocity) V of the vehicle 10, an acceleration sensor 44 that detects an acceleration or deceleration A of the vehicle 10, a lateral G sensor 46 that detects a lateral acceleration G of the vehicle 10, and a yaw rate sensor 48 that detects a yaw rate Y of the vehicle 10, an azimuth sensor (not shown) that detects an orientation of the vehicle 10, and a gradient sensor (not shown) that detects a gradient of the vehicle 10, etc.

Further, the vehicle sensors 14 include an operation detection sensor 50 that detects the presence or absence of operations, an operated amount, and an operated position of each of respective operative devices (an accelerator pedal, a steering wheel, a brake pedal, a shift lever, a direction indicator lever, etc.). For example, the vehicle sensors may include an accelerator pedal sensor 52 that detects an amount of depression (opening) of the accelerator, a steering angle sensor 54 that detects an operated amount (steering angle θs) of the steering wheel, a torque sensor 56 that detects a steering torque Tr, a brake pedal sensor 58 that detects an amount of depression of the brake, and a shift sensor (not shown) that detects a shift position, and the like.

The automatic driving SW 16 includes a start SW 60 and a stop SW 62. The start SW 60 outputs an initiation signal to the vehicle control device 20 in response to an operation from the user. The stop SW 62 outputs a stop signal to the vehicle control device 20 in response to an operation from the user. The cabin interior camera 18 captures an image of the driver's seat of the vehicle 10.

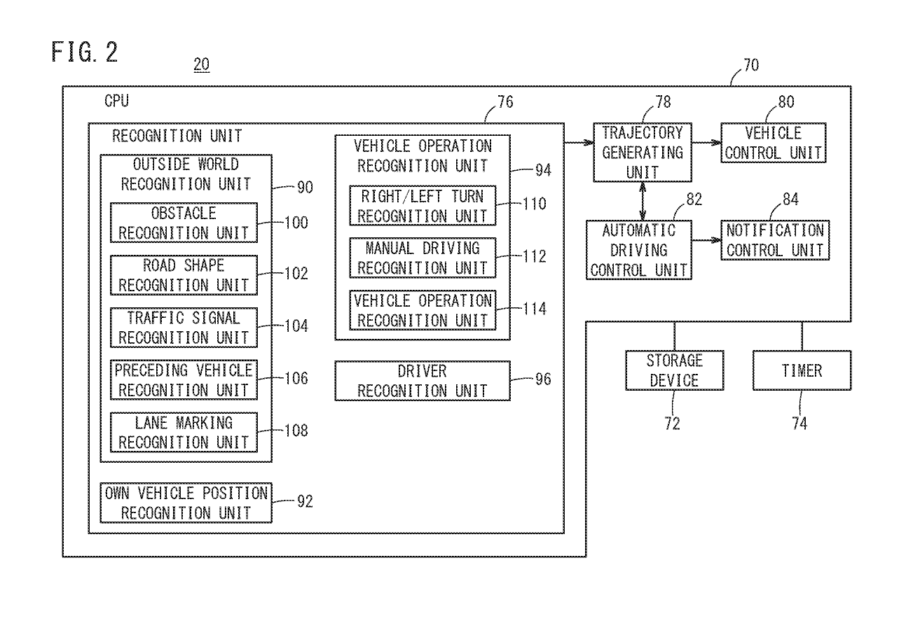

The vehicle control device 20 is constituted by one or more ECUs, and includes a CPU 70, a storage device 72, and a timer 74, etc. According to the present embodiment, by executing programs stored in the storage device 72, the CPU 70 realizes respective function realizing units 76, 78, 80, 82, and 84 (see FIG. 2). Moreover, the respective function realizing units 76, 78, 80, 82, and 84 can also be realized by way of hardware components made up from integrated circuits or the like.

The driving force device 22 includes a driving force ECU, and a drive source for the vehicle 10 such as an engine and/or a drive motor. The driving force device 22 generates a travel driving force (torque) in order for the vehicle 10 to travel in accordance with control instructions output from a vehicle control unit 80 (see FIG. 2), and transmits the travel driving force to the wheels directly or through a transmission.

The steering device 24 includes an EPS (electric power steering system) ECU, and an EPS device. The steering device 24 changes the orientation of the wheels (steered wheels) in accordance with control instructions output from the vehicle control unit 80 (see FIG. 2).

The braking device 26, for example, is an electric servo brake used in combination with a hydraulic brake, and includes a brake ECU and a brake actuator. The braking device 26 brakes the vehicle wheels in accordance with control instructions output from the vehicle control unit 80 (see FIG. 2).

Moreover, steering of the vehicle 10 can also be performed by changing a torque distribution or a braking force distribution to the left and right wheels.

The notification device 28 includes a notification ECU, and a display device and/or an audio device. The notification device 28 issues a notification concerning a manual driving request, and a procedure for initiating automatic driving, etc., in accordance with a notification command output from a notification control unit 84. The performance of the manual driving request is referred to as an H/O (handover) request.

### 2. Configuration of Vehicle Control Device 20

The vehicle control device 20 will now be described with reference to FIG. 2. As noted previously, the vehicle control device 20 includes the CPU 70, the storage device 72, and the timer 74. The CPU 70 functions as a recognition unit 76, a trajectory generating unit 78, the vehicle control unit 80, an automatic driving control unit 82, and the notification control unit 84.

The recognition unit 76 includes an outside world recognition unit 90, an own vehicle position recognition unit 92, a vehicle operation recognition unit 94, and a driver recognition unit 96.

Based on the various information acquired by the outside world information acquisition device 12, the outside world recognition unit 90 recognizes an outside world recognition target object, together with recognizing the position thereof. The outside world recognition unit 90 is further constituted by an obstacle recognition unit 100, a road shape recognition unit 102, a traffic signal recognition unit 104, a preceding vehicle recognition unit 106, and a lane marking recognition unit 108.

The obstacle recognition unit 100 recognizes an obstacle in front of the vehicle 10, on the basis of at least one of an image processing result of the image information from the external cameras 30, a detection result of the radar devices 32, and a detection result of the LIDAR devices 34. The road shape recognition unit 102 recognizes the shape (curvature, width, etc.) of the road in front of the vehicle 10, on the basis of the image processing result of the image information from the external cameras 30 and/or map information from the navigation device 36. The traffic signal recognition unit 104 recognizes the presence or absence of traffic signals existing in front of the vehicle 10, on the basis of the map information from the navigation device 36 and/or traffic signal information received by the communications device 38. Further, the traffic signal recognition unit 104 recognizes a signal from the traffic signal (a travel permission signal, a stop signal, a caution or yield signal, etc.) that exists in front of the vehicle 10, on the basis of an image processing result of image information from the external cameras 30 and/or traffic signal information received by the communications device 38. Based on at least one of the image processing result of the image information from the external cameras 30, the detection result of the radar devices 32, and the detection result of the LIDAR devices 34, the preceding vehicle recognition unit 106 recognizes a preceding vehicle that exists in front of the vehicle 10, as well as the inter-vehicle distance D between the preceding vehicle and the vehicle 10. The lane marking recognition unit 108 recognizes lane markings existing on both sides of the vehicle 10, on the basis of the image processing result of the image information from the external cameras 30 and/or the detection result of the LIDAR devices 34.

The own vehicle position recognition unit 92 recognizes the current position and attitude of the vehicle 10 based on position information of the vehicle 10 as measured by the navigation device 36, and sensor information detected by the vehicle sensors 14. Apart from the features mentioned above, instead of using the navigation device 36, it is also possible to measure the current position of the vehicle 10 using detected information from the satellite positioning device, the vehicle sensors 14, or the like, and thus to recognize the current position and attitude of the vehicle 10. Further, the own vehicle position recognition unit 92 recognizes the position of the vehicle 10 in the vehicle widthwise direction, on the basis of the positions of the lane markings recognized by the lane marking recognition unit 108.

The vehicle operation recognition unit 94 recognizes the behavior of the vehicle 10 on the basis of various information acquired from the outside world information acquisition device 12, and various detected information detected by the vehicle sensors 14. The vehicle operation recognition unit 94 further is constituted by a right/left turn recognition unit 110, a manual driving recognition unit 112, and a vehicle operation recognition unit 114.

The right/left turn recognition unit 110 recognizes whether the vehicle 10 is turning to the right or left, based on at least one of the position information of the vehicle 10 as measured by the navigation device 36, the image information from the external cameras 30, the detection result of the steering angle sensor 54, and a turn signal of the direction indicator. The judgment condition at the time of completion of the right or left turn can be set arbitrarily. For example, when a specified location or the entirety of the vehicle 10 has passed through a predetermined position (a lane start position or the like) of a new lane that is entered into after making the right or left turn, it can be judged that the right or left turn has been completed.

The manual driving recognition unit 112 recognizes whether manual driving is being executed or not, based on the detection result of the operation detection sensor 50. For example, in the case that the detection value of any one of the accelerator pedal sensor 52, the torque sensor 56, and the brake pedal sensor 58 is greater than or equal to a corresponding predetermined value, it is recognized that manual driving is being executed, whereas in the case that all of the detection values are less than their respective predetermined values, then it is recognized that manual driving is not being executed.

Based on the detection results of the vehicle sensors 14, the vehicle operation recognition unit 114 recognizes operations of the vehicle 10, which in this instance, are a velocity V, an acceleration or deceleration A, a steering angle θs, a yaw rate Y, a lateral acceleration G, and a yaw acceleration Y′ (a derivative value of the yaw rate Y), etc., of the vehicle 10. The acceleration or deceleration A is a value indicative of the amount of change per unit time (amount of motion) of the vehicle 10 in the longitudinal direction, and the lateral acceleration G and the yaw acceleration Y′ are values indicative of an amount of change per unit time (amount of motion) of the vehicle 10 in the vehicle widthwise direction. The amount of motion is an index indicative of the stability of the motion (behavior) of the vehicle 10. When the amount of motion is small, the operation (behavior) of the vehicle 10 is stable.

Based on the image information of the cabin interior camera 18, the driver recognition unit 96 recognizes the driving state (the direction of the face or the line of sight, the driving posture, etc.) of the driver. Apart therefrom, it is also possible to recognize grasping or non-grasping of the steering wheel by the driver, on the basis of the detection result of a touch sensor (not shown) provided on the steering wheel. Further, it is also possible to recognize seating or non-seating of the driver, on the basis of a detection result of a load sensor (not shown) provided in the driver's seat.

In order to cause the vehicle 10 to travel along the travel course following the road, the trajectory generating unit 78 generates a target travel trajectory and a target velocity for the vehicle 10, on the basis of the recognition result of the outside world recognition unit 90 and the recognition result of the own vehicle position recognition unit 92. When generating a target travel trajectory that is straight, the approximate center between the lane markings on both sides of the vehicle 10, as recognized by the lane marking recognition unit 108, is set as the target position.

The vehicle control unit 80 outputs control commands to the driving force device 22, the steering device 24, and the braking device 26. During automatic driving, the vehicle control unit 80 outputs control commands in order to cause the vehicle 10 to travel at the target velocity along the target travel trajectory that was generated by the trajectory generating unit 78, and during manual driving, outputs control commands on the basis of the detection results of the operation detection sensor 50.

The automatic driving control unit 82 comprehensively controls automatic driving. The automatic driving control unit 82 initiates automatic driving in accordance with the start signal that is output from the start SW 60, and stops automatic driving in accordance with a stop signal that is output from the stop SW 62. Further, the automatic driving control unit 82 stops automatic driving when a manual operation of any one of the operative devices is recognized by the manual driving recognition unit 112 during automatic driving. Furthermore, the automatic driving control unit 82 stops automatic driving in the event that the trajectory generating unit 78 is not capable of setting the target travel trajectory during automatic driving, for example, in the case that the lane marking recognition unit 108 cannot recognize the lane markings (including virtual lane markings). Further, the automatic driving control unit 82 temporarily stops automatic driving when the vehicle 10 turns to the right or left at an intersection. In addition, automatic driving is initiated (resumed) in the case that a predetermined condition is satisfied after having passed through the intersection. Further, the notification control unit 84 outputs a notification command with respect to the notification device 28.

The storage device 72 stores various programs and various predetermined values, for example, a maximum time Tmax, a first time T1 (T1<<Tmax), a second time T2 (T2<Tmax), a yaw acceleration threshold value Y′th, a lateral acceleration threshold value Gth, a velocity threshold value Vth, an acceleration or deceleration threshold value Ath, a curvature threshold value κth, a width threshold value Wth, a rate of change threshold value Dcth of the inter-vehicle distance D, an angle threshold value θdth between the vehicle 10 and the lane markings, and a steering torque threshold value Trth, etc., which are used in an automatic driving initiation process. The timer 74 measures an elapsed time T from the time at which the vehicle 10 finishes making a right or left turn.

### 3. Automatic Driving Initiation (Resumption) Process

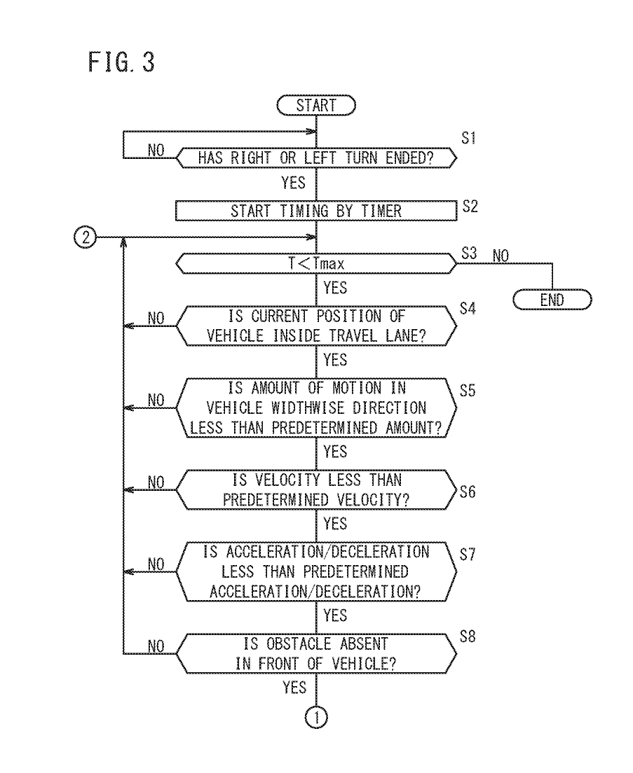

Using the flowcharts of FIGS. 3 to 5, a description will now be given concerning the process carried out by the vehicle control device 20 for initiating (resuming) automatic driving. In this instance, it is assumed that the vehicle 10 travels by way of automatic driving along a road.

When the driver operates the start SW 60 in a state in which automatic driving is possible, the automatic driving control unit 82 initiates automatic driving. Upon doing so, the vehicle 10 begins traveling by way of automatic driving along the road. During automatic driving along the road, the lane marking recognition unit 108 recognizes the lane markings on the basis of the image information acquired by the external cameras 30. When the vehicle 10 travels inside of a lane, the trajectory generating unit 78 generates the target travel trajectory along the lane markings, and when the vehicle 10 travels on a branching road at an intersection or the like, the trajectory generating unit 78 generates the target travel trajectory such that the vehicle 10 travels along an approach lane that is nearest to the straightforward direction. When turning to the right or left at the intersection during automatic driving along the road, the driver operates any one of the operative devices, for example, the direction indicator lever, in the right or left turning direction. Upon doing so, the automatic driving control unit 82 temporarily suspends automatic driving. When the driver initiates a steering operation to make a right or left turn, the manual driving recognition unit 112 recognizes that steering (the steering torque Tr) is being carried out by way of manual driving. The process of initiating (starting) automatic driving, which will be described below, is initiated from this point in time. In the process to be described below, the subject of each of the determination processes is the automatic driving control unit 82.

In step S1, it is determined whether a right or left turn of the vehicle 10 has finished. If the right/left turn recognition unit 110 recognizes completion of the right or left turn of the vehicle 10 (step S1: YES), the process proceeds to step S2. On the other hand, in the case that the right/left turn recognition unit 110 has not recognized completion of the right or left turn (step S1: NO), the process of step S1 is repeatedly executed.

In step S2, measurement of an elapsed time T by the timer 74 is initiated. In step S3, a comparison between the elapsed time T and the maximum time Tmax is performed. If the elapsed time T is less than the maximum time Tmax (step S3: YES), the process proceeds to step S4. On the other hand, in the case that the elapsed time T is greater than or equal to the maximum time Tmax (step S3: NO), a timeout is determined, and the automatic driving initiation process is terminated. Since it is necessary to operate the start SW 60 again for the purpose of resuming automatic driving, a notification may be performed by the notification device 28 to the effect that, in order for automatic driving to be resumed, it is necessary to operate the start SW 60 again.

In step S4, it is determined whether or not the current position of the vehicle 10 is inside of the travel lane. If the own vehicle position recognition unit 92 recognizes that the vehicle 10 is traveling inside of the travel lane (step S4: YES), the process proceeds to step S5. On the other hand, in the case it is recognized that the vehicle 10 is not traveling inside the travel lane (step S4: NO), the process returns to step S3.

In step S5, it is determined whether the amount of motion of the vehicle 10 in the vehicle widthwise direction is less than a predetermined amount. The amount of motion of the vehicle 10 in the vehicle widthwise direction as recognized by the vehicle operation recognition unit 114, for example, is determined by whether or not the yaw acceleration Y′ is less than the yaw acceleration threshold value Y′th, or whether or not the lateral acceleration G is less than the lateral acceleration threshold value Gth. When the amount of motion in the vehicle widthwise direction is less than a predetermined amount, there is a high possibility that positional adjustment in the vehicle widthwise direction after having made a right or left turn in the vehicle 10 has ended. In this case (step S5: YES), the process proceeds to step S6. On the other hand, when the amount of motion in the vehicle widthwise direction is greater than or equal to the predetermined amount, there is a high possibility that positional adjustment in the vehicle widthwise direction after having made a right or left turn in the vehicle 10 has not ended. In this case (step S5: NO), the process returns to step S3.

In step S6, it is determined whether or not the velocity V of the vehicle 10 is less than a predetermined velocity. When the velocity V of the vehicle 10 as recognized by the vehicle operation recognition unit 114 is less than the velocity threshold value Vth, there is a high possibility that positional adjustment in the longitudinal direction after having made a right or left turn in the vehicle 10 has ended. In this case (step S6: YES), the process proceeds to step S7. On the other hand, when the velocity V is greater than or equal to the velocity threshold value Vth, there is a high possibility that positional adjustment in the longitudinal direction after having made a right or left turn in the vehicle 10 has not ended. In this case (step S6: NO), the process returns to step S3.

In step S7, it is determined whether or not the acceleration or deceleration A of the vehicle 10 is less than a predetermined acceleration or deceleration. When the acceleration or deceleration A of the vehicle 10 as recognized by the vehicle operation recognition unit 114 is less than the acceleration or deceleration threshold value Ath, there is a high possibility that positional adjustment in the longitudinal direction after having made a right or left turn in the vehicle 10 has ended. In this case (step S7: YES), the process proceeds to step S8. On the other hand, when the acceleration or deceleration A is greater than or equal to the acceleration or deceleration threshold value Ath, there is a high possibility that positional adjustment in the longitudinal direction after having made a right or left turn in the vehicle 10 has not ended. In this case (step S7: NO), the process returns to step S3.

In step S8, it is determined whether or not there is an obstacle in front of the vehicle 10. If an obstacle is not recognized by the obstacle recognition unit 100 (step S8: YES), the process proceeds to step S9. On the other hand, in the case that an obstacle is recognized (step S8: NO), the process returns to step S3.

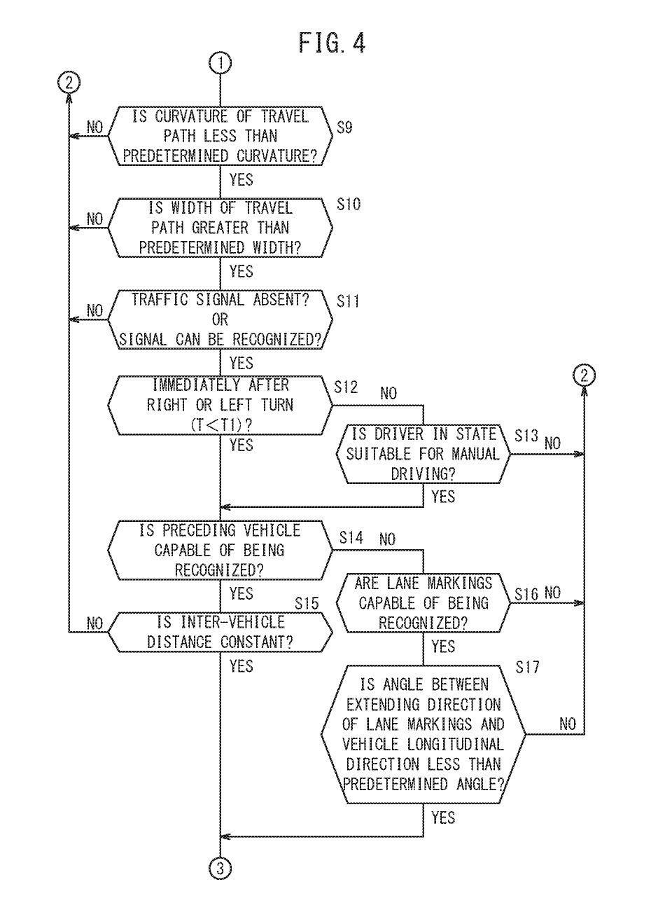

Moving onto FIG. 4, the description will be continued. In step S9, a determination is made as to whether the curvature κ of the travel path in front of the vehicle 10 is less than a predetermined curvature. If the curvature κ of the travel path as recognized by the road shape recognition unit 102 is less than the curvature threshold value κth (step S9: YES), the process proceeds to step S10. On the other hand, in the case that the curvature κ of the travel path is greater than or equal to the curvature threshold value κth (step S9: NO), the process returns to step S3.

In step S10, a determination is made as to whether or not the width W of the travel path in front of the vehicle 10 is greater than a predetermined width. If the width W of the travel path as recognized by the road shape recognition unit 102 is greater than the width threshold value Wth (step S10: YES), the process proceeds to step S11. On the other hand, in the case that the width W of the travel path is less than or equal to the width threshold value Wth (step S10: NO), the process returns to step S3.

In step S11, a determination is made as to whether or not a traffic signal exists in front of the vehicle 10, and whether or not the signal thereof can be recognized. If the existence of a traffic signal is not recognized by the traffic signal recognition unit 104, or if the signal of the traffic signal is recognized (step S11: YES), the process proceeds to step S12. On the other hand, when the existence of the traffic signal is recognized, and the signal of the traffic signal cannot be recognized (step S11: NO), the process returns to step S3.

In step S12, a determination is made as to whether a right or left turn of the vehicle 10 has just been completed. In this instance, the elapsed time T is compared with a predetermined first time T1. If the elapsed time T is less than the first time T1 (step S12: YES), then it is immediately after having made a turn to the right or left, and thus the process skips step S13, and proceeds to step S14. On the other hand, in the case that the elapsed time T is greater than or equal to the first time T1 (step S12: NO), then since it is not immediately after having made a turn to the right or left, the process proceeds to step S13.

In step S13, a determination is made as to whether or not the driver is in a state suitable for manual driving. In a case in which the state of the driver as recognized by the driver recognition unit 96 is a state that is suitable for driving, for example, if the driver faces the front, the driver is visually perceiving the front of the vehicle, the driver is seated, and the steering wheel is being gripped or the like (step S13: YES), the process proceeds to step S14. On the other hand, in the case that the state of the driver is not suitable for driving (step S13: NO), the process returns to step S3.

In step S14, a determination is made as to whether or not a preceding vehicle is capable of being recognized. If a preceding vehicle is recognized by the preceding vehicle recognition unit 106 (step S14: YES), the process proceeds to step S15. On the other hand, in the case that the preceding vehicle is not recognized (step S14: NO), the process proceeds to step S16.

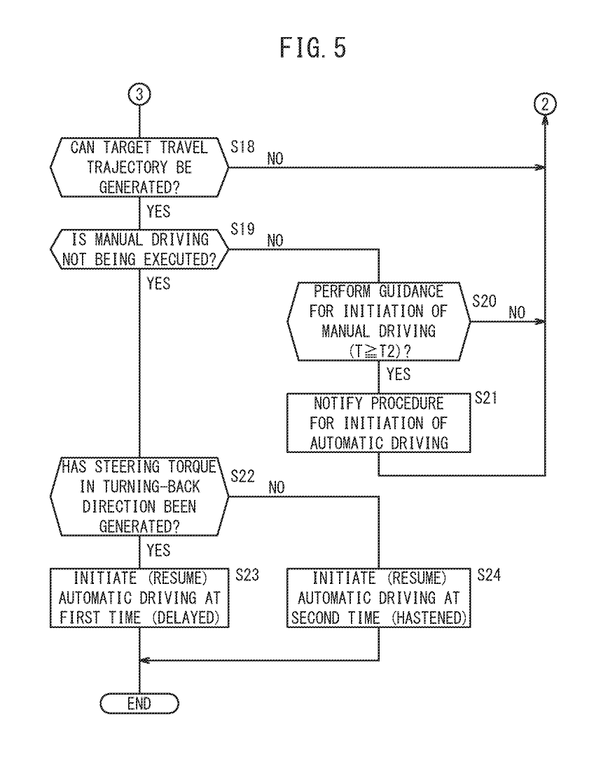

In the case of transitioning from step S14 to step S15, a determination is made as to whether or not the inter-vehicle distance D between the vehicle 10 and the preceding vehicle is constant. If the rate of change Dc of the inter-vehicle distance D as recognized by the preceding vehicle recognition unit 106 is less than the rate of change threshold value Dcth (step S15: YES), the process proceeds to step S18 (see FIG. 5). On the other hand, in the case that the rate of change Dc is greater than or equal to the rate of change threshold value Dcth (step S15: NO), the process returns to step S3.

In the case of transitioning from step S14 to step S16, a judgment is made as to whether or not the lane markings are capable of being recognized. If the lane markings are recognized by the lane marking recognition unit 108 (step S16: YES), the process proceeds to step S17. On the other hand, in the case that the lane markings are not recognized (step S16: NO), the process returns to step S3.

In step S17, a determination is made as to whether or not the angle θd between the longitudinal direction of the vehicle 10 and the direction in which the lane markings extend is less than a predetermined angle. The direction in which images are captured by the external cameras 30 lies parallel to the longitudinal direction of the vehicle 10. Therefore, based on the image information from the external cameras 30, the lane marking recognition unit 108 is capable of recognizing the angle θd between the longitudinal direction of the vehicle 10 and the direction in which the lane markings extend. If the angle θd recognized by the lane marking recognition unit 108 is less than the angle threshold value θdth (step S17: YES), the process proceeds to step S18 (see FIG. 5). On the other hand, in the case that the angle θd is greater than or equal to the angle threshold value θdth (step S17: NO), the process returns to step S3.

Moving onto FIG. 5, the description will be continued. In step S18, a determination is made as to whether or not a target travel trajectory is capable of being generated. The trajectory generating unit 78 is capable of generating a target travel trajectory in the case that lane markings are recognized by the lane marking recognition unit 108. If a target travel trajectory is capable of being generated by the trajectory generating unit 78 (step S18: YES), the process proceeds to step S19. On the other hand, in the case that the target travel trajectory cannot be generated (step S18: NO), the process returns to step S3.

In step S19, a determination is made as to whether or not manual driving is being executed. In the case that the driver desires to switch from manual driving to automatic driving, the degree of manual driving, and more specifically, the operated amounts of the accelerator pedal, the steering wheel, and the brake pedal are reduced. If execution of manual driving is not recognized by the manual driving recognition unit 112 (step S19: YES), the process proceeds to step S22. On the other hand, in the case that execution of manual driving is recognized (step S19: NO), the process proceeds to step S20.

If a transition is made from step S19 to step S20, it is determined whether or not to perform guidance for the initiation of manual driving. In this instance, the elapsed time T is compared with a predetermined second time T2. If the elapsed time T is greater than or equal to the second time T2 (step S20: YES), the process proceeds to step S21. On the other hand, in the case that the elapsed time T is less than the second time T2 (step S20: NO), the process returns to step S3. In step S21, the notification control unit 84 outputs a notification command with respect to the notification device 28 in order to notify the driver of the procedure for initiation of automatic driving. The notification device 28 notifies the driver of the procedure for initiation of automatic driving by a display and/or voice in accordance with the notification command. In addition, the process returns to step S3.

If a transition is made from step S19 to step S22, a determination is made as to whether or not the steering torque Tr in the turning-back direction has been generated (or whether the steering torque Tr is less than or equal to the steering torque threshold value Trth). In the first half of a right or left turn, the operation to turn the steering wheel is performed by the driver, whereas in the second half of a right or left turn, two cases occur: in one case, the operation to turn back the steering wheel is performed by the driver; and in the other case, the operation to turn back the steering wheel is performed by a self-aligning torque. If the operation of turning back the steering wheel is performed by the driver, a steering torque Tr in the turning-back direction is generated. In this case (step S22: YES), the process proceeds to step S23. On the other hand, in the case that the operation of turning back the steering wheel is performed by the self-aligning torque, a steering torque Tr in the turning-back direction is not generated. In this case (step S22: NO), the process proceeds to step S24.

If a transition is made from step S22 to step S23, the automatic driving control unit 82 initiates (resumes) automatic driving at a first point in time. Since the driver positively performs the steering operation at the time of turning to the right or left, there is a possibility that manual driving can be continued for a while immediately after turning to the right or left. Therefore, in this instance, the point in time that switching takes place from manual driving to automatic driving is delayed.

If a transition is made from step S22 to step S24, the automatic driving control unit 82 initiates (resumes) automatic driving at a second point in time which occurs sooner than the first point in time. Since the driver conducts the steering operation in a passive manner at the time of turning right or left, there is a possibility that it is desired to switch rapidly to automatic driving. Therefore, in this instance, the point in time that switching takes place from manual driving to automatic driving is hastened.

### 4. Summary of the Present Embodiment

the vehicle control device 20 according to the present embodiment is equipped with the right/left turn recognition unit 110 adapted to recognize a right or left turn of the vehicle 10, the trajectory generating unit 78 adapted to generate a target travel trajectory for the vehicle 10, and the manual driving recognition unit 112 adapted to recognize that manual driving is being executed. There is further provided the automatic driving control unit 82, which initiates automatic driving under a condition in which, after the manual driving recognition unit 112 has recognized execution of manual driving, and the right/left turn recognition unit 110 has recognized the completion of a right or left turn of the vehicle (step S1: YES), the control unit is placed in a state of being capable of generating a target travel trajectory by the trajectory generating unit 78 (step S18: YES), and in addition, the manual driving recognition unit 112 no longer recognizes execution of manual driving (step S19: YES). According to the present embodiment, automatic driving is resumed unless the driver is engaged in manual driving at a point in time when the target travel trajectory is capable of being generated, and after having made a right or left turn by way of manual driving. Therefore, it is possible to rapidly resume automatic driving without the need for the driver to perform a complicated operation such as operating a button.

In the present embodiment, the trajectory generating unit 78 generates a target travel trajectory along the travel route following a road. According to the present embodiment, when automatic driving is taking place along a road for which a destination point is not set, the driver performs only right or left turning at intersections by way of manual driving, and thereafter, automatic driving can be continued.

The vehicle control device 20 includes an own vehicle position recognition unit 92 that recognizes the current position of the vehicle 10, and a vehicle operation recognition unit 114 that recognizes operations of the vehicle 10. Regardless of the aforementioned condition, if the own vehicle position recognition unit 92 recognizes that the current position of the vehicle 10 is within a lane (step S4: YES), and the vehicle operation recognition unit 114 recognizes that an amount of change per unit time of the vehicle 10 in the vehicle widthwise direction is greater than or equal to a predetermined amount, for example, in the case that the lateral acceleration G or the yaw acceleration Y′ is greater than or equal to a predetermined amount (step S5: NO), then the automatic driving control unit 82 does not initiate automatic driving. According to the present embodiment, automatic driving is not resumed when an amount of change (amount of motion) per unit time of the vehicle 10 in the vehicle widthwise direction is large. More specifically, since there are no significant steering operations being performed immediately after switching from manual driving to automatic driving, the riding comfort of the vehicle 10 can be favorably maintained.

The vehicle control device 20 is equipped with the vehicle operation recognition unit 114 that recognizes operations of the vehicle 10. Regardless of the aforementioned condition, the vehicle operation recognition unit 114 recognizes that the velocity V is greater than or equal to a predetermined velocity (the velocity threshold value Vth) (step S6: NO), or the vehicle operation recognition unit 114 recognizes that an acceleration or deceleration A is greater than or equal to a predetermined acceleration or deceleration (the acceleration or deceleration threshold value Ath) (step S7: NO), then the automatic driving control unit 82 does not initiate automatic driving. According to the present embodiment, automatic driving is not resumed when the velocity V of the vehicle 10 is greater than or equal to the predetermined velocity (the velocity threshold value Vth), or when the acceleration or deceleration A of the vehicle 10 is greater than or equal to the predetermined acceleration or deceleration (the predetermined acceleration or deceleration threshold value Ath). More specifically, since there are no significant acceleration or deceleration operations being performed immediately after switching from manual driving to automatic driving, the riding comfort of the vehicle 10 can be favorably maintained.

The vehicle control device 20 further comprises the obstacle recognition unit 100 adapted to recognize an obstacle in front of the vehicle 10. Regardless of the aforementioned condition, if the obstacle is recognized by the obstacle recognition unit 100 (step S8: NO), then the automatic driving control unit 82 does not initiate automatic driving. In the event that an obstacle is present in front of the vehicle 10 after having made a right or left turn, it is more efficient for manual driving to be continued as is, and to carry out a contact avoidance action, rather than carrying out such a contact avoidance action by way of automatic driving after having switched from manual driving to automatic driving. According to the present embodiment, if an obstacle is present in front of the vehicle 10, automatic driving is not initiated, and therefore, it is possible to efficiently perform the contact avoidance action with respect to the obstacle.

The vehicle control device 20 further comprises the road shape recognition unit 102 that recognizes the curvature κ of the travel path. Regardless of the aforementioned condition, if the road shape recognition unit 102 recognizes that the curvature κ is greater than or equal to a predetermined curvature (curvature threshold value κth) (step S9: NO), then the automatic driving control unit 82 does not initiate automatic driving. During automatic driving, when the curvature of the travel path in front of the vehicle 10 is large, in certain cases, driving of the vehicle 10 should be entrusted to the driver. According to the present embodiment, automatic driving is not initiated in the case that the curvature κ of the travel path in front of the vehicle 10 is large. More specifically, since there is no need for such a series of operations that switching is made from manual driving to automatic driving immediately after having made a right or left turn, and immediately thereafter, switching is made again from automatic driving to manual driving due to the curvature κ of the travel path being large, the processing burden at the time of switching the driving mode is eliminated. Further, since automatic driving is not stopped again immediately after having been initiated, it is possible to prevent the driver from being confused.

The vehicle control device 20 further comprises the road shape recognition unit 102 that recognizes the width W of the travel path. Regardless of the aforementioned condition, if the road shape recognition unit 102 recognizes that the width W is less than or equal to a predetermined width (width threshold value Wth) (step S10: NO), then the automatic driving control unit 82 does not initiate automatic driving. During automatic driving, when the width W of the travel path in front of the vehicle 10 is small, in certain cases, driving of the vehicle 10 should be entrusted to the driver. According to the present embodiment, automatic driving is not initiated in the case that the width W of the travel path in front of the vehicle 10 is small. More specifically, since there is no need for such a series of operations that switching is made from manual driving to automatic driving immediately after having made a right or left turn, and immediately thereafter, switching is made again from automatic driving to manual driving due to the width W of the travel path being small, the processing burden at the time of switching the driving mode is eliminated. Further, since automatic driving is not stopped again immediately after having been initiated, it is possible to prevent the driver from being confused.

The vehicle control device 20 further comprises the traffic signal recognition unit 104 that recognizes a traffic signal installed in front of the vehicle 10, and a signal indicated by the traffic signal. Regardless of the aforementioned condition, if the existence of a traffic signal is recognized by the traffic signal recognition unit 104, and the signal indicated by the traffic signal is not recognized (step S11: NO), the automatic driving control unit 82 does not initiate automatic driving. If it is recognized that there is a traffic signal in front of the vehicle 10 after having made a right or left turn, and the signal shown by the traffic signal cannot be recognized, it is more efficient to continue manual driving as is, and to entrust the determination of operations to the driver. According to the present embodiment, in the case it is recognized that there is a traffic signal in front of the vehicle 10, yet the signal shown by the traffic signal cannot be recognized, automatic driving is not initiated, and therefore, driving can be performed efficiently.

The vehicle control device 20 further comprises the driver recognition unit 96 that recognizes the driver. Regardless of the aforementioned condition, if the driver recognition unit 96 recognizes that the driver is not in a state suitable for manual driving (step S13: NO), then the automatic driving control unit 82 does not initiate automatic driving. In general, in the vehicle 10 which is in the process of being driven automatically, in preparation for a sudden request to change from automatic driving to manual driving, it is preferable for the driver to be in a state suitable for performing manual driving, for example, in a state of sitting or visually confirming the front of the vehicle 10. For this reason, a condition suitable for manual driving may be set as a requirement for automatic driving. According to the present embodiment, automatic driving is not initiated in the case of a state that is unsuitable for manual driving, or in other words, since automatic driving is only initiated in a state suitable for manual driving, it is possible to satisfy the requirement for automatic driving.

Moreover, immediately after completion of a right or left turn by the vehicle 10 is recognized by the right/left turn recognition unit 110 (step S12: YES), the automatic driving control unit 82 does not use the recognition result by the driver recognition unit 96 in determining whether or not to initiate automatic driving. Immediately after the driver makes a right or left turn by way of manual driving, the driver is in a state suitable for manual driving. According to the present embodiment, since the detection result by the driver recognition unit 96 is not used at this time, the processing burden at the time of switching the driving mode is reduced.

The vehicle control device 20 further comprises the preceding vehicle recognition unit 106 adapted to recognize a preceding vehicle traveling in front of the vehicle 10. If a preceding vehicle is recognized by the preceding vehicle recognition unit 106 (step S14: YES), then the automatic driving control unit 82 determines the start of automatic driving on the basis of the preceding vehicle. According to the present embodiment, in the case that a preceding vehicle can be recognized, it is possible to perform automatic driving in following relation to the preceding vehicle.

The vehicle control device 20 further comprises the lane marking recognition unit 108 adapted to recognize lane markings of the lane in which the vehicle 10 travels. If a preceding vehicle is not recognized by the preceding vehicle recognition unit 106 (step S14: NO), then the automatic driving control unit 82 determines the start of automatic driving on the basis of the lane markings recognized by the lane marking recognition unit 108. According to the present embodiment, even if a preceding vehicle cannot be recognized, in the event that lane markings can be recognized, the vehicle 10 can be made to travel along the lane markings.

The manual driving recognition unit 112 recognizes the steering torque Tr input by the steering wheel. If the steering torque Tr in the turning-back direction is recognized by the manual driving recognition unit 112 (step S22: YES) when a turning-back operation of the steering wheel is performed, the automatic driving control unit 82 delays the time of initiating automatic driving (step S23). Further, if the steering torque Tr in the turning-back direction is not recognized by the manual driving recognition unit 112 (step S22: NO), the time of initiating automatic driving is hastened (step S24). When a steering turning-back operation is performed, in the case that a steering torque Tr in the turning-back direction is generated, such a turning-back operation is performed by the driver. In other words, the driver positively carries out manual driving. On the other hand, when a steering turning-back operation is performed, in the case that a steering torque Tr in the turning-back direction is not generated, such a turning-back operation is performed by a self-aligning torque. In other words, the driver leaves the responsibility for driving to the vehicle 10. According to the present embodiment, when the driver leaves the responsibility for driving to the vehicle 10, it is possible to rapidly initiate automatic driving.

The vehicle control device 20 further comprises the timer 74 that measures the elapsed time T from recognition of completion of a right or left turn by the vehicle 10 by the right/left turn recognition unit 110, and the notification control unit 84 that instructs the notification device concerning a procedure for initiating automatic driving, in the case that manual driving is recognized by the manual driving recognition unit 112 even if the elapsed time T is greater than or equal to a predetermined time (second time T2) (step S19: NO, step S20: YES). According to the present embodiment, it is possible to remind or cause the driver to realize that automatic driving can be initiated.

### 5. Modifications

The vehicle control device 20 according to the present invention is not limited to the embodiment described above, and it is a matter of course that various modified or additional configurations could be adopted therein without deviating from the scope of the present invention.

For example, in the above-described embodiment, it is assumed that automatic driving involves traveling along a travel route following a road. However, the present invention is not limited to the above embodiment, and can also be used for automatic driving in which the vehicle 10 is caused to travel along a travel route generated by the navigation device 36, and switching to manual driving occurs when making a right or left turn at an intersection.

Further, the automatic driving initiation (resumption) process may be of a manner in which automatic driving is initiated when the conditions of step S1, step S18, and step S19 shown in FIGS. 3 to 5 are satisfied. Furthermore, in such an automatic driving initiation (resumption) process, one or more of the processes shown in FIGS. 3 to 5 may be combined.

What is claimed is:

1. A vehicle control device disposed in a vehicle that is capable of traveling by automatic driving, comprising:
a right/left turn recognition unit configured to recognize a right or left turn of the vehicle;
a trajectory generating unit configured to generate a target travel trajectory for the vehicle;
a manual driving recognition unit configured to recognize that manual driving is being executed; and
an automatic driving control unit configured to initiate automatic driving under a condition in which, after the manual driving recognition unit has recognized execution of manual driving, and the right/left turn recognition unit has recognized completion of a right or left turn of the vehicle, a state of being capable of generating the target travel trajectory by the trajectory generating unit is brought about, and in addition, the manual driving recognition unit no longer recognizes execution of manual driving.

2. The vehicle control device according to claim 1, wherein the trajectory generating unit generates the target travel trajectory along a travel route following a road.

3. The vehicle control device according to claim 1, further comprising:
an own vehicle position recognition unit configured to recognize a current position of the vehicle; and
a vehicle operation recognition unit configured to recognize an operation of the vehicle;
wherein, regardless of the condition, if the own vehicle position recognition unit recognizes that the current position is within a lane, and the vehicle operation recognition unit recognizes that an amount of change per unit time of the vehicle in a vehicle widthwise direction is greater than or equal to a predetermined amount, then the automatic driving control unit does not initiate automatic driving.

4. The vehicle control device according to claim 1, further comprising:
a vehicle operation recognition unit configured to recognize an operation of the vehicle;
wherein, regardless of the condition, if the vehicle operation recognition unit recognizes that a velocity of the vehicle is greater than or equal to a predetermined velocity, or the vehicle operation recognition unit recognizes that an acceleration or deceleration of the vehicle is greater than or equal to a predetermined acceleration or deceleration, then the automatic driving control unit does not initiate automatic driving.

5. The vehicle control device according to claim 1, further comprising:
an obstacle recognition unit configured to recognize an obstacle in front of the vehicle;
wherein, regardless of the condition, if the obstacle is recognized by the obstacle recognition unit, then the automatic driving control unit does not initiate automatic driving.

6. The vehicle control device according to claim 1, further comprising:
a road shape recognition unit configured to recognize a curvature of a travel path;
wherein, regardless of the condition, if the road shape recognition unit recognizes that the curvature is greater than or equal to a predetermined curvature, then the automatic driving control unit does not initiate automatic driving.

7. The vehicle control device according to claim 1, further comprising:
a road shape recognition unit configured to recognize a width of a travel path;
wherein, regardless of the condition, if the road shape recognition unit recognizes that the width is less than or equal to a predetermined width, then the automatic driving control unit does not initiate automatic driving.

8. The vehicle control device according to claim 1, further comprising:
a traffic signal recognition unit configured to recognize presence or absence of a traffic signal installed in front of the vehicle, and a signal shown by the traffic signal;
wherein, regardless of the condition, if the traffic signal recognition unit recognizes that the traffic signal is present, but does not recognize the signal shown by the traffic signal, then the automatic driving control unit does not initiate automatic driving.

9. The vehicle control device according to claim 1, further comprising:
a driver recognition unit configured to recognize a driver;
wherein, regardless of the condition, if the driver recognition unit recognizes that the driver is not in a state suitable for manual driving, then the automatic driving control unit does not initiate automatic driving.

10. The vehicle control device according to claim 1, further comprising:
a preceding vehicle recognition unit configured to recognize a preceding vehicle traveling in front of the vehicle;
wherein, if the preceding vehicle is recognized by the preceding vehicle recognition unit, then the automatic driving control unit determines start of automatic driving on basis of the preceding vehicle.

11. The vehicle control device according to claim 10, wherein, if a rate of change of an inter-vehicle distance as recognized by the preceding vehicle recognition unit is less than a rate of change threshold value, then the automatic driving control unit does not initiate automatic driving.

12. The vehicle control device according to claim 10, further comprising:
a lane marking recognition unit configured to recognize a lane marking of a lane in which the vehicle is traveling;
wherein, if the preceding vehicle is not recognized by the preceding vehicle recognition unit, then the automatic driving control unit determines the start of automatic driving on basis of the lane marking recognized by the lane marking recognition unit.

13. The vehicle control device according to claim 12, wherein:
the lane marking recognition unit recognizes an angle between a longitudinal direction of the vehicle and a direction in which the lane marking extends; and
if the angle recognized by the lane marking recognition unit is greater than or equal to an angle threshold value, then the automatic driving control unit does not initiate automatic driving.

14. The vehicle control device according to claim 1, wherein:
the manual driving recognition unit recognizes a steering torque input by a steering wheel; and
when a steering turning-back operation is performed, the automatic driving control unit delays a time of starting automatic driving in a case that a steering torque in a turning-back direction is recognized by the manual driving recognition unit, and hastens a time of starting automatic driving in a case that the steering torque in the turning-back direction is not recognized by the manual driving recognition unit.

15. The vehicle control device according to claim 1, further comprising a notification control unit configured to instruct a notification device concerning a procedure for initiating automatic driving, in a case that manual driving is recognized by the manual driving recognition unit even if an elapsed time from having recognized the completion of a right or left turn of the vehicle by the right/left turn recognition unit is greater than or equal to a predetermined time.
